(19) United States
(12) Patent Application Publication
(10) Pub. No.: US 2025/0254602 A1
(43) Pub. Date: Aug. 7, 2025

(54) METHODS AND APPARATUSES FOR USER EQUIPMENT LOCATION VERIFICATION

(71) Applicant: Lenovo (Beijing) Limited, Beijing (CN)

(72) Inventors: Min Xu, Beijing (CN); Lianhai Wu, Beijing (CN); Jing Han, Beijing (CN); Ran Yue, Beijing (CN); Jie Hu, Beijing (CN)

(73) Assignee: Lenovo (Beijing) Limited, Beijing (CN)

(21) Appl. No.: 18/856,203

(22) PCT Filed: Apr. 15, 2022
(86) PCT No.: PCT/CN2022/087166

§ 371 Date: Oct. 11, 2024

(51) Int. Cl. H04W 48/04; H04W 56/00; H04W 64/00; H04W 76/20

(52) U.S. Cl. CPC H04W 48/04; H04W 56/0045; H04W 64/00; H04W 76/20

(57) ABSTRACT

Disclosed are methods and apparatuses for user equipment (UE) location verification. An embodiment of the subject application provides a UE including: a processor; and a wireless transceiver coupled to the processor, herein the processor is configured to, with the wireless transceiver: receive a report configuration for UE location verification from a base station (BS); and transmit a report including parameters for the UE location verification to the BS, wherein the parameters include at least one of the following in different types: at least two timing advance (TA) values associated with at least two different time points respectively for a radio access network (RAN) node; at least two propagation delay values associated with at least two different time points respectively for a RAN node; or at least two propagation delay values associated with at least two RAN nodes respectively at a time point.

### TECHNICAL FIELD

The present disclosure generally relates to wireless communications, and especially to user equipment (UE) location verification.

### BACKGROUND OF THE INVENTION

In some cases with satellite access or High Altitude Platform (HAP) access, mobile network services can be offered through radio access technologies whose coverage could extend well beyond the political borders of countries wherein regulations of communication services could be different. Such network coverage is considered as extraterritorial network coverage, which may cover several countries and/or regions at the same time, while laws, rules, or regulations in these countries and/or regions may be different from each other.

For example, Public Warning System (PWS) and its different regional variants are generally covered by regulatory requirements (e.g. laws or other regulations). Issues with extraterritoriality can appear when it is not clear which of the national or regional regulatory requirements apply, including: whether PWS should be supported; which of the regional versions of PWS must be supported by the operator; which agencies or local authorities can be the Warning Notification Provider.

For example, regarding charging and billing system, several countries have concluded that income deriving from satellite services is income generated within their territory. This implies that the satellite operator may be subject to paying value added and income tax for the services provided to customers in that country. It is therefore important that the charging and billing system of the satellite operator can identify in which country a UE was located when it was receiving services from the satellite network.

For example, regarding emergency calls, different countries and regions can have different types of emergency calls. Furthermore, similar types of emergency calls may use different numbers in different countries. Another aspect related to extraterritoriality is that emergency calls need to be routed to the correct Public Safety Answering Point (PSAP). Routing to the right PSAP may be done based on the basis of UE location.

For example, regarding lawful intercept, specifically information indicating the target of interception, is often not allowed to be provided to networks outside the jurisdiction of the country. This may e.g. imply that the satellite ground station and/or base station and the core network all have to be in the same country as the UE. The location information needs to be trusted by the 3GPP network (i.e. network derived or verified).

For example, regarding data retention policy, regulations for data retention as part of data privacy and trade law exists for different sovereign states. If the UE location is ambiguous with respect to the sovereign state territory in which the UE operates, then a cross-border condition arises. The operator should apply the regulations according to the country where UE is in.

For example, regarding network access, regional/national regulators may also define exclusion areas where non-terrestrial communication is not allowed. Operators of non-terrestrial network (NTN) should ensure that their networks do not provide service in exclusion areas. Meanwhile when an NTN uses spectrum that is subject to licensing in a specific country or region it will have to ensure it has permission from the countries or regions that are covered.

### SUMMARY

Some embodiments of the present disclosure provide a UE including: a processor; and a wireless transceiver coupled to the processor, herein the processor is configured to, with the wireless transceiver: receive a report configuration for UE location verification from a base station (BS); and transmit a report including parameters for the UE location verification to the BS, wherein the parameters include at least one of the following in different types: at least two timing advance (TA) values associated with at least two different time points respectively for a radio access network (RAN) node; at least two propagation delay values associated with at least two different time points respectively for a RAN node; or at least two propagation delay values associated with at least two RAN nodes respectively at a time point.

In some embodiments, the report configuration includes at least one of: a Boolean indication indicating the UE to transmit the report; an enumeration indication indicating which type(s) of parameters to be reported; a number indication indicating how many values for each type of parameters included in the report; a first time duration with which the parameters included in the report are associated; a second time duration within which the UE location verification is completed; or an interval threshold between each two time points for a type of parameters associated with a RAN node.

In some embodiments, in the case that the report configuration includes the second time duration, the processor is configured to start a timer which expires upon an end of the second time duration.

In some embodiments, the timer stops if random access (RA) or initial access to the BS is successfully completed.

In some embodiments, wherein the report configuration is received via system information broadcast or dedicated signaling.

In some embodiments, each type of parameters within the report includes: a full value as reference and at least one differential value; or at least two full values.

In some embodiments, the report is transmitted via MAC CE in Msg3 payload or MsgA payload during RA.

In some embodiments, the parameters are transmitted in each Msg3 payload or MsgA payload.

In some embodiments, each of the parameters is transmitted in a repeated Msg3 payload or MsgA payload respectively in the case that message repetition is enabled in RA.

In some embodiments, the report is transmitted via radio resource control (RRC) signaling when the UE is in an RRC connected state.

In some embodiments, the processor is further configured to enter or fallback to an RRC idle state in response to receiving an indication indicting an failure of the UE location verification from the BS or expiry of the timer.

In some embodiments, the processor is further configured to be forbidden from attempting to access a current cell in a network or cells in the network for a third time duration.

In some embodiments, the processor is further configured to: receive an indication indicating a success of the UE location verification from the BS; and set up RRC connection with the BS or keep in an RRC connected state.

Some embodiments of the present disclosure provide a BS including: a transceiver; and a processor coupled to the transceiver, wherein the processor is configured to, with the wireless transceiver: acquire a verified UE location based on at least ephemeris data associated with at least one RAN node; and determine, based on the verified UE location, whether to deny access request from a UE or release a current RRC connection with the UE, or set up an RRC connection or keep the current RRC connection with the UE.

In some embodiments, the ephemeris data or a system information block (SIB) included in the ephemeris data includes at least one of: orbital parameters of the at least one RAN node; a position and a velocity vector of the at least one RAN node; epoch time of the ephemeris data of the at least one RAN node; validity time of the ephemeris data of the at least one RAN node.

In some embodiments, to acquire the verified UE location, the processor is configured to, with the wireless transceiver: transmit a report configuration for UE location verification; receive a report including parameters for the UE location verification from the UE, wherein the parameters are associated with the at least one RAN node, and the verified UE location is acquired based on at least the ephemeris data and the parameters.

In some embodiments, the report configuration further includes at least one of: a Boolean indication indicating the UE to transmit the report; an enumeration indication indicating which type(s) of parameters to be reported; a number indication indicating how many values for each type of parameters included in the report; a first time duration with which the parameters included in the report are associated; a second time duration in which the UE location verification is completed; or an interval threshold between each two time points for to a type of parameters associated with a RAN node.

In some embodiments, the report configuration is transmitted via system information broadcast or dedicated signaling.

In some embodiments, the parameters includes at least one of the following in different types: at least two TA values associated with at least two different time points respectively for the at least one RAN node; at least two propagation delay values associated with at least two different time points respectively for the at least one RAN node; or at least two propagation delay values associated with at least two RAN nodes respectively at the same time point, wherein the at least one RAN node includes the at least two RAN nodes.

In some embodiments, each type of parameters within the report includes: a full value as reference and at least one differential value; or at least two full values.

In some embodiments, the report is received via MAC CE in Msg3 payload or MsgA payload during RA.

In some embodiments, the parameters are included in each Msg3 payload or MsgA payload.

In some embodiments, each of the parameter is included in a repeated Msg3 payload or MsgA payload respectively in the case that message repetition is enabled in RA.

In some embodiments, the report is received via RRC signaling when the UE is in an RRC connected state.

In some embodiments, to acquire the verified UE location, the processor is configured to: derive a UE location based on at least the parameters and ephemeris data; and determine the verified UE location based on at least the derived UE location.

In some embodiments, to acquire the verified UE location, the processor is further configured to, with the wireless transceiver: transmit assistance information to a location service (LCS) entity for UE location verification; and receive the verified UE location from the LCS entity, herein the assistance information includes at least the parameters and the ephemeris data of at least one RAN node associated with the report.

In some embodiments, the processor is configured to transmit the assistance information and receive the verified UE location via inter-node protocol with the wireless transceiver.

In some embodiments, to acquire the verified UE location, the processor is configured to, with the wireless transceiver: transmit at least the ephemeris data to an LCS entity for UE location verification; and receive the verified UE location from the LCS entity.

In some embodiments, processor is further configured to, with the wireless transceiver, transmit reference signal measurement result(s) to the LCS entity for the UE location verification.

In some embodiments, the verified UE location includes at least one of: a flag indication indicating whether the UE is located in a not-allowed or allowed country or region; an indication indicting a country or region where the UE is located; or a location in coordinates.

In some embodiments, in the case that the verified UE location indicates that the UE is located in a not-allowed country or region, the determination includes at least: denying access request from the UE or releasing a current RRC connection with the UE.

In some embodiments, the processor is further configured to perform at least one of: transmitting an indication indicting a failure of the UE location verification to the UE; or forbidding the UE from attempting to access a current cell in a network or cells in the network for a third time duration.

In some embodiments, in the case that the verified UE location indicates that the UE is located in an allowed country or region, the determination includes at least one of: selecting an access management entity in a determined country or region for the UE; or setting up an RRC connection or keeping the current RRC connection with the UE.

In some embodiments, the processor is further configured to: transmit an indication indicating a success of the UE location verification to the UE.

Some embodiments of the present disclosure provide an LCS entity including: a transceiver; and a processor coupled to the transceiver, herein the processor is configured to, with the wireless transceiver: receive assistance information including at least ephemeris data or at least one type of parameters for UE location verification from a BS; and derive a verified UE location based on the assistance information; and transmit the verified UE location to the BS.

In some embodiments, 36. The LCS entity of claim 35, wherein the assistance information further includes at least one type of parameters of following: at least two TA values associated with at least two different time points respectively for the same RAN node; at least two propagation delay values associated with at least two different time points respectively for the same RAN node; or at least two propagation delay values associated with at least two RAN nodes respectively at the same time point.

In some embodiments, the ephemeris data or an SIB included in the ephemeris data includes at least one of: orbital parameters of the at least one RAN node; a position and a velocity vector of the at least one RAN node; epoch time of the ephemeris data of the at least one RAN node; validity time of the ephemeris data of the at least one RAN node.

In some embodiments, the verified UE location is indicated as at least one of: a flag indication indicating whether the UE is located in a not-allowed or allowed country or region; an indication indicting a country or region where the UE is located; or a location in coordinates.

In some embodiments, the processor is configured to receive the assistance information and transmit the verified UE location via inter-node protocol with the wireless transceiver.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 (includes 1(a) and 1(b)) illustrates examples using TA values or propagation delay values for UE location verification according to some embodiments of the present disclosure.

FIG. 2 illustrates an exemplary method performed by a BS according to some embodiments of the present disclosure.

FIG. 3 illustrates an exemplary signaling flow chart according to some embodiments of the present disclosure.

FIG. 4 illustrates an exemplary signaling flow chart according to some embodiments of the present disclosure.

FIG. 5 illustrates an exemplary signaling flow chart according to some embodiments of the present disclosure.

FIG. 6 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

As aforementioned, the laws, rules, or regulations of different countries and/or regions in extraterritorial network coverage may be different from each other. Accordingly, it is better to perform UE location verification and determine whether the UE is within an allowed country or region, or whether it is allowed to access a network belonging to a country or a region, so as to avoid possible problems such as those related to extraterritoriality.

This invention proposes a UE location verification solution for a UE in extraterritorial network coverage, which is based on enhancements to Non-terrestrial Network (NTN) specific UE reporting parameters (e.g., timing advance (TA), propagation delay, or etc.). One advantage is that the solution does not need user consent and no new reference signal or UE measurement is needed.

According to some embodiments of the present disclosure, TA values are used for UE location verification. Although TA values are not originally for positioning or location verification purposes, TA values reported by a UE can somehow reveal information of the UE location. According to some embodiments of the present disclosure, the TA values can be reported in Msg3 or MsgB during RA procedure, or reported when the UE is in RRC connected mode.

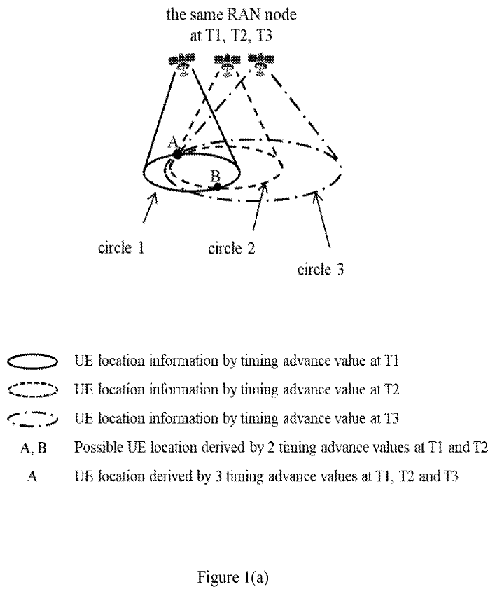

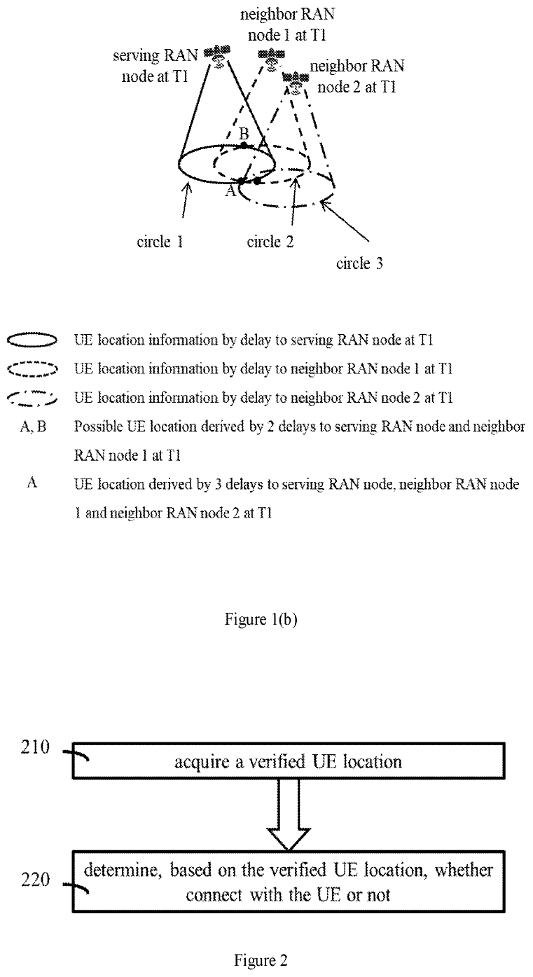

FIG. 1(a) indicates an example about deriving a UE location based on TA values at different time points (T1, T2 and T3). The positions on circle 1 have the same TA value 1 at T1, the positions on circle 2 have the same TA value 2 at T2, and the positions on circle 3 have the same TA value 3 at T3. If two TA values, e.g., TA value 1 at T1 and TA value 2 at T2, are used for UE location verification, the possible UE location is derived to be at position A or position B. If three TA values (i.e., TA value 1 at T1, TA value 2 at T2, and TA value 3 at T3) are used for UE location verification, then the UE location is derived to be at position A. It can be seen that, in this example, the more TA values associated with the same RAN node at different time points are used, the more accurate the UE location is derived. In this example, the RAN node may be a satellite.

According to some embodiments of the present disclosure, propagation delay values can be used for UE location verification. Propagation delay values may for example, assist a network in configuring appropriate measurement gap or window in an RRC connected mode for the UE; although they are not originally for positioning or location verification purposes, they can somehow reveal information of the UE location. According to some embodiments of the present disclosure, the propagation delay values may be reported in Msg3 or MsgB during RA procedure, in RRC signaling when the UE is in RRC connected mode before AMF selection.

FIG. 1(b) indicates an example about deriving a UE location based on propagation delay values associated with different RAN nodes (a serving RAN node, a neighbor RAN node 1, and a neighbor RAN node 2) at the same time point T1. The positions on circle 1 have the same propagation delay value 1, the positions on circle 2 have the same propagation delay value 2, and the positions on circle 3 have the same propagation delay value 3. If two propagation delay values, e.g., propagation delay value 1 and propagation delay value 2 at the same time point T1, are used for UE location verification, then the possible UE location is derived to be at position A or position B. If three propagation delay values (i.e., propagation delay value 1, propagation delay value 2, and propagation delay value 3) are used for UE location verification, then the UE location is derived to be at position A. It can be seen that, in this example, the more propagation delay values associated with different RAN nodes at the same time point, the more accurate the UE location is derived. In this example, each RAN node may be a satellite.

By leveraging additional UE report of TA or propagation delay, the provided solution either implements UE location verification at a BS or implements UE location verification requested by BS at an LCS entity based on based on at least one of TA, propagation delay, ephemeris data, and etc. According to the solution of the present disclosure, a verified UE location is essential in access control or network entity selection under extraterritorial network coverage. In particular, the proposed solution can be performed during initial access to a network and before any core network entity is selected, which allows BS to deny or accept the access request from the UE, select appropriate access and mobility management function (AMF) entity or construct cell identity.

According to some embodiments of the present disclosure, the UE location verification is performed based on at least one of:
ephemeris data associated with at least one RAN node;
parameters (e.g., TA or propagation delay) associated with the at least one RAN node reported from the UE; and
reference signal measurement result(s) reported from the UE.

In some embodiments, if the UE location verification is performed based on at least both the ephemeris data and the parameters of the report transmitted from the UE, the ephemeris data is associated with the at least one RAN node that the parameters are associated with.

In some embodiments, the ephemeris data may include at least one of:
orbital parameters of the at least one RAN node;
a position and a velocity vector of the at least one RAN node;
epoch time of the ephemeris data of the at least one RAN node; or
validity time of the ephemeris data of the at least one RAN node.

In some embodiments, the ephemeris data may include an SIB, and the SIB includes the aforementioned content.

In some embodiments, the BS may transmit a report configuration to the UE for acquiring parameters (e.g., TA or propagation delay) for UE location verification. In some embodiments, the report configuration includes at least one of:
a Boolean indication indicating the UE to transmit the report;
an enumeration indication indicating which type(s) of parameters to be reported; in some embodiments, the type(s) of parameters includes at least one of the following:
   at least two TA values associated with at least two different time points respectively for the same RAN node;
   at least two propagation delay values associated with at least two different time points respectively for the same RAN node; or
   at least two propagation delay values associated with at least two RAN nodes respectively at the same time point;
a number indication indicating how many values for each type of parameters included in the report; in some embodiments, for each type of parameters to be reported, there should be at least two parameter values to be report, and the more of the parameter values, the more accurate the UE position is derived or verified;
a first time duration with which the parameters included in the report are associated; for example, referring back to FIG. 1(a), T1, T2, and T3 should be in the first time duration from the reception of the report configuration;
a second time duration within which the UE location verification is completed; for example, the UE location verification should be finished within the second time duration from the reception of the report configuration; or
an interval threshold between each two time points for a type of parameters associated with a RAN node; referring back to FIG. 1(a) as an example, the interval between T1 and T2, the interval between T1 and T3, and the interval between T2 and T3 should not be less than the interval threshold.

In some embodiments, the UE received the report configuration from the BS via system information broadcast or dedicated signaling.

According to some embodiments of the present disclosure, after reception of the configuration report from the BS, the UE may report at least one type of parameters indicated in the report configuration to the BS for UE location verification.

In some embodiments, if the report configuration includes the second time duration, the UE may starts a timer upon the reception of the report configuration, and the timer will expire upon an end of the second time duration from the reception of the report configuration. In some embodiments, the timer stops if RA or initial access to the BS is successfully completed. In some embodiments, if the timer expires, it means that the UE location verification for the UE fails, and the UE may enter or fall back to an RRC idle state.

In some embodiments, the report configuration includes an enumeration indication, and the enumeration indication indicates to report at least two TA values associated with at least two different time points respectively for the same RAN node. In some embodiments, the at least two TA values are collected during an RA procedure if the UE location verification is performed in the RA procedure. In some embodiments, the at least two TA values are collected in an RRC connected mode if the UE location verification is performed in the RRC connected mode. In some embodiments, the at least two TA values may include a full value as reference and at least one differential value. In some embodiments, all the at least two TA values may be full values.

An example about TA values is illustrated in Table 1; herein the report configuration includes a number indication, and the number indication indicates 3 TA values associated with 3 time points for the same RAN node (e.g., RAN node 1) are included in the report.

TABLE 1

| | TA values | | |
|---|---|---|---|
| | | x2 or Δx2 = | x3 or Δx3 = |
| | x1 | x2 − x1 | x3 − x1 |
| Time point associated | T1 | T2 | T3 |
| RAN node associated | RAN node 1 | RAN node 1 | RAN node 1 |
| | (serving) | (serving) | (serving) |

In some embodiments of Table 1, an interval between each two time points (e.g., between T1 and T2, between T1 and T3, between T2 and T3) is not less than the interval threshold indicated in the report configuration.

In some embodiments, the report configuration includes an enumeration indication, and the enumeration indication indicates to report at least two propagation delay values associated with at least two different time points respectively for the same RAN node. In some embodiments, the at least two propagation delay values are collected during an RA procedure if the UE location verification is performed in the RA procedure. In some embodiments, the at least two propagation delay values are collected in an RRC connected mode if the UE location verification is performed in the RRC connected mode. In some embodiments, the at least two propagation delay values may be a full value as reference and at least one differential value. In some embodiments, all the at least two propagation delay values may be full values.

An example about propagation delay values is illustrated in Table 2; herein the report configuration includes a number indication, and the number indication indicates 3 propagation delay values associated with 3 time points for the same RAN node (e.g., RAN node 1) are included in the report.

TABLE 2

| | propagation delay value | | |
|---|---|---|---|
| | | y2 or Δy2 = | y3 or Δy3 = |
| | y1 | y2 − y1 | y3 − y1 |
| Time point associated | T1 | T2 | T3 |
| RAN node associated | RAN node 1 | RAN node 1 | RAN node 1 |
| | (serving) | (serving) | (serving) |

In some embodiments of Table 2, each interval between each two time points (e.g., between T1 and T2, between T1 and T3, between T2 and T3) is not less than the interval threshold indicated in the report configuration.

In some other embodiments, the report configuration includes an enumeration indication, and the enumeration indication indicates to report at least two propagation delay values associated with at least two RAN nodes respectively at the same time point. In some embodiments, the at least two propagation delay values are collected during RA procedure if the UE location verification is performed in the RA procedure. In some embodiments, the at least two propagation delay values are collected in an RRC connected mode if the UE location verification is performed in the RRC connected mode. In some embodiments, the at least two propagation delay values may be a full value as reference and at least one differential value. In some embodiments, all the at least two propagation delay values may be full values.

An example about propagation delay values is illustrated in Table 3; herein the report configuration includes a number indication, and the number indication indicates 3 TA values associated with the same time points for 3 different RAN nodes (e.g., RAN node 1, RAN node 2, and RAN node 3) are included in the report.

TABLE 3

| | propagation delay value | | |
|---|---|---|---|
| | | z2 or Δz2 = | z3 or Δz3 = |
| | z1 | z2 − z1 | z3 − z1 |
| Time point associated | T1 | T1 | T1 |
| RAN node associated | RAN node 1 | RAN node 2 | RAN node 3 |
| | (serving) | (neighbor) | (neighbor) |

In some embodiments, the UE location verification is performed in an RA procedure; the UE transmit the report to the BS via MAC CE in Msg3 payload or MsgA payload during RA. In some embodiments, the parameters included by the report are transmitted in each Msg3 payload or MsgA payload. In some embodiments, each of the parameters included by the report is transmitted in a repeated Msg3 payload or MsgA payload respectively in the case that message repetition is enabled in RA.

In some embodiments, the UE location verification is performed in the RRC connected mode; the UE transmits the report via RRC signaling.

FIG. 2 illustrates an exemplary method 200 performed by a BS for UE location verification. As illustrated in FIG. 2, method 200 includes operation 210 and operation 220; herein in operation 210, the BS acquires a verified UE location by itself or with support from an LCS entity; in operation 220, the BS determines, based on the verified UE location, whether connect with the UE or not.

In some embodiments, in operation 210, the BS may acquire a verified UE location by itself base on at least one of: the ephemeris data associated with at least one RAN node, TA values or propagation delay values, or reference signal measurement result(s). Specifically, the BS derives a UE location based on at least one of the ephemeris data associated with at least one RAN node, TA values or propagation delay values, or reference signal measurement result(s); and determines a verified UE location based on the derived UE location.

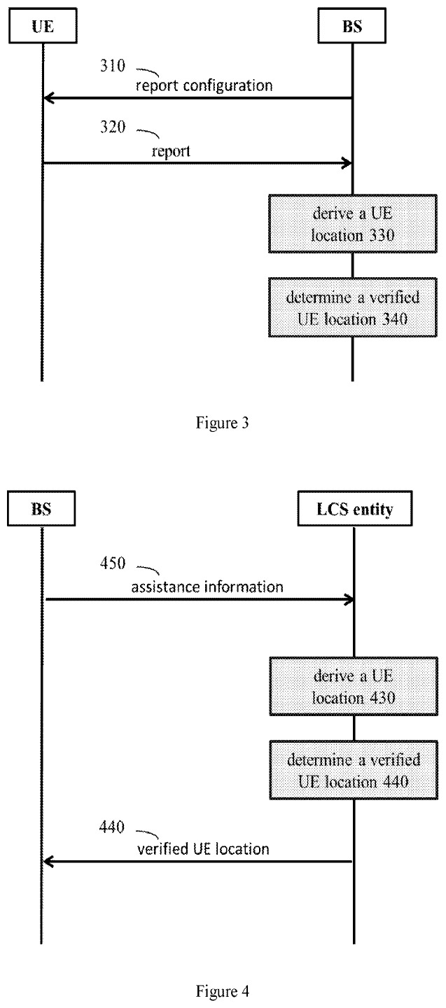

FIG. 3 illustrates an exemplary signaling flow chart about acquire a verified UE location by the BS itself. As illustrated in FIG. 3, the BS transmits report configuration 310 to the UE, and receives a report 320 from the UE, wherein the report 320 includes at least one type of parameters according to the report configuration 310. After reception of the report 320, the BS derives a UE location 330 based on at least the at least one type of parameters included in the report, and determines a verified UE location 340 based on the derived UE location 330. In some embodiments, the BS may derive a UE location based on the at least one type of parameters associated with at least one RAN node and the ephemeris data associated with the at least one RAN node. In some embodiments, the derived UE location may be further based on reference signal measurement results(s) reported by the UE.

In some embodiments, in operation 210, the BS may transmit assistance information to an LCS entity and acquire a verified UE location from the LCS entity. In some embodiments, the assistance information may include the ephemeris data associated with at least one RAN node. In some embodiments, the assistance information may further include reference signal measurement result(s) reported from the UE. In some embodiments, the BS transmits the assistance information to the LCS entity and receives the verified UE location from the LCS entity via inter-node protocol.

FIG. 4 illustrates an exemplary signaling flow chart about acquire a verified UE location by the usage of an LCS entity. As illustrated in FIG. 4, the BS may transmit assistance information 450 to an LCS entity; herein the assistance information 450 includes at least one of: the ephemeris data associated with at least one RAN node, or reference signal measurement result(s) reported from the UE. Then the LCS entity derives a UE location 430 based on the assistance information 450, and determines a verified UE location 440 based on the derived UE location 430. Then the LCS entity transmits the verified UE location 440 to the BS, and the BS acquires the verified UE location 440.

In some embodiments, in operation 210, the BS may transmit a report configuration to the UE and get at least one type of parameters associated with at least one RAN node via a report transmitted from the UE; then the BS transmit assistance information to an LCS entity for acquiring a verified UE location from the LCS entity. In some embodiments, the assistance information includes the at least one type of parameters associated with the at least one RAN node. In some embodiments, the assistance information may further include at least one of: the ephemeris data associated with the at least one RAN node, and reference signal measurement result(s) reported from the UE. In some embodiments, the BS transmits the assistance information to the LCS entity and receives the verified UE location from the LCS entity via inter-node protocol.

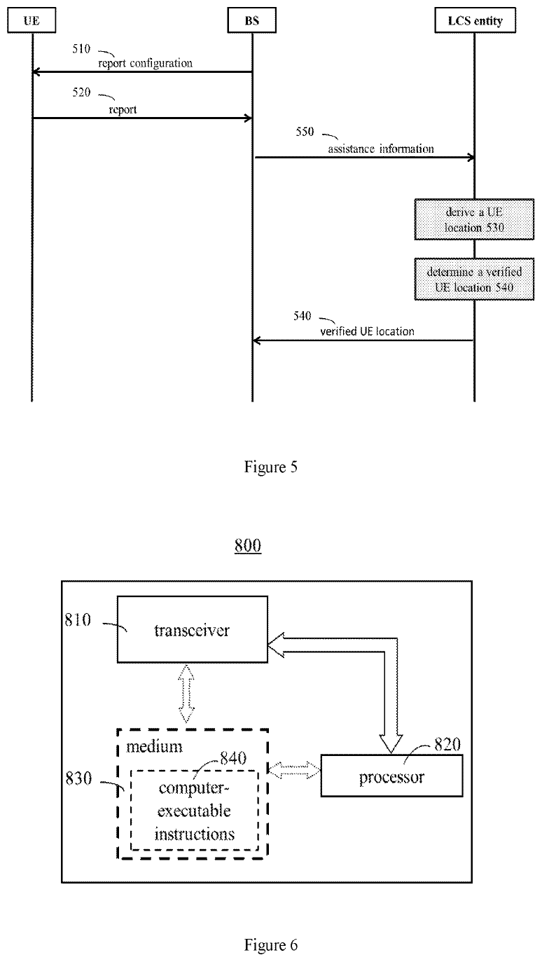

FIG. 5 illustrates an exemplary signaling flow chart about acquire a verified UE location by the usage of an LCS entity. As illustrated in FIG. 5, the BS transmits a report configuration 510 to the UE, and receives a report 520 from the UE, wherein the report 420 includes at least one type of parameters associated with at least one RAN node according to the report configuration 510. After reception of the report 520, the BS transmits assistance information 550 to the LCS entity; herein the assistance information 550 includes at least the at least one type of parameters to the LCS entity. In some embodiments, the assistance information 550 may further include at least one of: the ephemeris data associated with the at least one RAN node and reference signal measurement result(s) reported from the UE. After reception of the assistance information 550, the LCS entity derives a UE location 530 based on the assistance information 550, and determines a verified UE location 540 based on the derived UE location 530. Then the LCS entity transmits the verified UE location 540 to the BS, and the BS acquires the verified UE location 540. In some embodiments, the BS transmits the assistance information 550 to the LCS entity and receives the verified UE location from the LCS entity via inter-node protocol.

According to some embodiments of the present disclosure, in operation 210, the verified UE location includes at least one of:
a flag indication indicating whether the UE is located in a not-allowed or allowed country or region;
an indication indicting a country or region where the UE is located; or
a location in coordinates.

In some embodiments, in operation 220, if the UE location verification is performed in an RA procedure, the BS determines, based on the verified UE location, whether to deny access request from the UE or set up an RRC connection with the UE. In some embodiments when the UE location verification is performed in an RA procedure, if the verified UE location indicates that the UE is located in a not-allowed country or region, the BS may deny an access request from the UE; if the verified UE location indicates that the UE is located in an allowed country or region, the BS determines to set up an RRC connection with the UE.

In some embodiments, in operation 220, if the UE location verification is performed in an RRC connection mode, the BS determines, based on the verified UE location, whether to release a current RRC connection with the UE or keep the current RRC connection with the UE. In some embodiments when the UE location verification is performed in the RRC connection mode, if the verified UE location indicates that the UE is located in a not-allowed country or region, the BS may release a current RRC connection with the UE; if the verified UE location indicates that the UE is located in an allowed country or region, the BS determines to keep the current RRC connection with the UE

In some embodiments, if the verified UE location indicates that the UE is located in a not-allowed country or region, the BS may further transmit an indication indicting a failure of the UE location verification to the UE. In some embodiments upon reception of the indication indicating a failure of the UE location verification, the UE may enter or fallback to an RRC idle state.

In some embodiments, if the verified UE location indication indicates that the UE is located in a not-allowed country or region, the UE may be forbidden from attempting to access a current cell (or the BS) in a network or cells in the network for a third time duration.

In some embodiments, if the verified UE location indicates that the UE is located in an allowed country or region, the BS or a network may further select an access management entity in a determined country or region for the UE. In some embodiments, if the verified UE location indicates that the UE is located in an allowed country or region, the UE may further receive an indication indicating a success of the UE location verification.

According to various methods or embodiments of the present disclosure, a UE location verification solution for extraterritorial network coverage is provided, which aims to solve the issue of verifying UE's location at network side for country/region-based access control or network service entity selection in extraterritorial network coverage e.g. NTN. By leveraging additional UE report of timing advance or propagation delay, the proposed solutions either implement UE location verification at BS (i.e., BS-verified UE location) based on a report including certain parameters (e.g., at least two TA values or propagation delay values) and/or ephemeris data of at least one associated RAN node, or implement UE location verification requested by BS at an LCS entity (i.e., network-verified UE location) based on at least the UE report and/or ephemeris data associated with at least one associated RAN node.

According to various methods or embodiments of the present disclosure, based on the verified UE location, the BS or network implement access control or network entity selection under an extraterritorial network coverage.

Furthermore, in particular, the provided solutions can be performed during an initial access and before any core network entity is selected, in addition to be able to performed in an RRC connected mode, which allows BS to deny/accept service, select appropriate AMF entity or construct cell identity based on the verified UE location.

In particular, according to various methods or embodiments of the present disclosure, no user consent and no new reference signal or UE measurement is needed; the solution of the present disclosure are proposed based on enhancements to NTN-specific UE reporting contents (e.g., TA or propagation delay); this is an advantage of the present disclosure.

FIG. 6 illustrates a simplified block diagram of an exemplary apparatus 800 according to various embodiments of the present disclosure.

In some embodiments, the apparatus 800 may be or include at least a part of a UE or similar device having similar functionality.

In some embodiments, the apparatus 800 may be or include at least a part of a BS or similar device having similar functionality.

In some embodiments, the apparatus 800 may be or include at least a part of an LCS entity (e.g., location management function (LMF)) or similar device having similar functionality.

As shown in FIG. 6, the apparatus 800 may include at least wireless transceiver 810 and processor 820, wherein wireless transceiver 810 may be coupled to processor 820. Furthermore, the apparatus 800 may include non-transitory computer-readable medium 830 with computer-executable instructions 840 stored thereon, wherein non-transitory computer-readable medium 830 may be coupled to processor 820, and computer-executable instructions 840 may be configured to be executable by processor 820. In some embodiments, wireless transceiver 810, non-transitory computer-readable medium 830, and processor 820 may be coupled to each other via one or more local buses.

Although in FIG. 6, elements such as wireless transceiver 810, non-transitory computer-readable medium 830, and processor 820 are described in the singular, the plural is contemplated unless limitation to the singular is explicitly stated.

In certain embodiments of the present disclosure, the apparatus 800 may further include other components for actual usage.

In some embodiments, the apparatus 800 is a UE or at least a part of a UE. In some embodiments, the processor 820 is configured to: receive, with wireless transceiver 810: receive a report configuration for UE location verification from a BS; and transmit a report including parameters for the UE location verification to the BS, wherein the parameters include at least one of the following in different types:
at least two TA values associated with at least two different time points respectively for an RAN node;
at least two propagation delay values associated with at least two different time points respectively for a RAN node; or
at least two propagation delay values associated with at least two RAN nodes respectively at a time point.

In some embodiments, the processor 820 is configured to transmit, with the transceiver 810, the report via MAC CE in Msg3 payload or MsgA payload during RA.

In some embodiments, the processor 820 is configured to transmit, with the transceiver 810, the report via RRC signaling when the UE is in an RRC connected state.

In some embodiments, the processor 820 is configured to enter or fallback to an RRC idle state in response to receiving an indication indicting an failure of the UE location verification from the BS or expiry of a timer associated with a second time duration configured in the report configuration; in some embodiments, the processor 820 is configured to be forbidden from attempting to access a current cell in a network or cells in the network for a third time duration.

In some embodiments, the processor 820 is configured to receive an indication indicating a success of the UE location verification from the BS and set up RRC connection with the BS or keep in an RRC connected state.

In some other embodiments, the apparatus 800 is a BS or at least a part of a BS. In some embodiments, the processor 820 is configured to, with the transceiver 810: acquire a verified UE location based on at least ephemeris data associated with at least one RAN node; and determine, based on the verified UE location, whether to deny access request from a UE or release a current RRC connection with the UE, or set up an RRC connection or keep the current RRC connection with the UE. In some embodiments, the verified UE location includes at least one of:
a flag indication indicating whether the UE is located in a not-allowed or allowed country or region;
an indication indicting a country or region where the UE is located; or
a location in coordinates.

In some embodiments, the processor 820 is configured to, with the transceiver 810, transmit a report configuration for UE location verification; and receive a report including parameters for the UE location verification from the UE, wherein the parameters are associated with the at least one RAN node, and the verified UE location is acquired based on at least the ephemeris data and the parameters. In some embodiments, the report configuration further includes at least one of:
a Boolean indication indicating the UE to transmit the report;
an enumeration indication indicating which type(s) of parameters to be reported;
a number indication indicating how many values for each type of parameters included in the report;
a first time duration with which the parameters included in the report are associated;
a second time duration in which the UE location verification is completed; or
an interval threshold between each two time points for to a type of parameters associated with a RAN node.

In some embodiments, to acquire the verified UE location, the processor 820 is configured to acquire the verified UE location, the processor is configured to: derive a UE location based on at least one of the parameters associated with at least one RAN node, reference signal measurement result(s), and ephemeris data; and determine the verified UE location based on at least the derived UE location.

In some embodiments, to acquire the verified UE location, the processor 820 is configured to transmit at least one of at least the parameters included in the report and the ephemeris data of at least one RAN node associated with the report to an LCS entity for UE location verification; and receive the verified UE location from the LCS entity, wherein the assistance information includes at least the parameters and the ephemeris data of at least one RAN node associated with the report. In some embodiments, the processor 820 may further transmit reference signal measurement result(s) to the LCS entity for the UE location verification.

In some embodiments, the processor 820 is configured to transmit, with the transceiver 810, the assistance information and receive the verified UE location via inter-node protocol with the wireless transceiver.

In some embodiments, in the case that the verified UE location indicates that the UE is located in a not-allowed country or region, the processor 820 determines at least: denying access request from the UE or releasing a current RRC connection with the UE. In some embodiments, the processor 820 is further configured to transmit, with the transceiver 810, an indication indicting an failure of the UE location verification to the UE, and forbid the UE from attempting to access a current cell in a network or cells in the network for a third time duration.

In some embodiments, in the case that the verified UE location indicates that the UE is located in an allowed country or region, the processor 820 is configured to determine to: select an access management entity in a determined country or region for the UE; or set up an RRC connection or keeping the current RRC connection with the UE. In some embodiments, the processor 820 is further configured to transmit, with the transceiver 810, an indication indicting a success of the UE location verification to the UE.

In some furthermore embodiments, apparatus 800 is an LCS entity. Processor 820 is configured to, with wireless transceiver 810, receive assistance information including at least ephemeris data or at least one type of parameters for UE location verification from a BS; and derive a verified UE location based on the assistance information; and transmit the verified UE location to the BS.

In various example embodiments, processor 820 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, processor 820 may also include at least one other circuitry or element not shown in FIG. 8.

In various example embodiments, non-transitory computer-readable medium 830 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, non-transitory computer-readable medium 830 may include, but is not limited to, an electric, a magnetic, an optical, an electromagnetic, an infrared, or a semiconductor system, apparatus, or device or any combination of the above.

Further, in various example embodiments, exemplary apparatus 800 may also include at least one other circuitry, element, and interface, for example antenna element, and the like.

In various example embodiments, the circuitries, parts, elements, and interfaces in exemplary apparatus 800, including processor 820 and non-transitory computer-readable medium 830, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

In this disclosure, relational terms such as “first,” “second,” and the like may be used solely to distinguish one entity or action from another entity or action without necessarily requiring or implying any actual such relationship or order between such entities or actions.

1. A user equipment (UE) for wireless communication, comprising:
at least one memory; and
at least one processor coupled with the at least one memory and configured to cause the UE to:
receive a report configuration for UE location verification from a base station (BS); and
transmit a report including parameters for the UE location verification to the BS, wherein the parameters include, in different types, at least one of:
at least two timing advance (TA) values associated with at least two different time points respectively for a radio access network (RAN) node;
at least two propagation delay values associated with at least two different time points respectively for the RAN node; or
at least two propagation delay values associated with at least two RAN nodes respectively at a time point.

2. The UE of claim 1, wherein the report configuration includes at least one of:
a Boolean indication indicating to the UE to transmit the report;
an enumeration indication indicating which one or more types of parameters to be reported;
a number indication indicating how many values for each type of parameter included in the report;
a first time duration with which the parameters included in the report are associated;
a second time duration within which the UE location verification is completed; or
an interval threshold between each two time points for a type of parameters associated with the RAN node.

3. The UE of claim 1, wherein each type of parameter within the report includes:
a full value as reference and at least one differential value; or
at least two full values.

4. The UE of claim 1, wherein the at least one processor is configured to cause the UE to transmit the report via at least one medium access control control element (MAC CE) in Msg3 payload or MsgA payload during random access (RA).

5. The UE of claim 1, wherein the at least one processor is further configured to cause the UE to:
enter or fallback to a radio resource control (RRC) idle state in response to receiving an indication indicting a failure of the UE location verification from the BS or expiry of a timer.

6. A base station (BS) for wireless communication, comprising:
at least one memory; and
at least one processor coupled with the at least one memory and configured to cause the BS to:
acquire a verified user equipment (UE) location based on at least ephemeris data associated with at least one radio access network (RAN) node; and
determine, based on the verified UE location, whether to deny access request from a UE or release a current radio resource control (RRC) connection with the UE, or set up an RRC connection or keep the current RRC connection with the UE.

7. The BS of claim 6, wherein the ephemeris data or a system information block (SIB) included in the ephemeris data includes at least one of:
orbital parameters of the at least one RAN node;
a position and a velocity vector of the at least one RAN node;
epoch time of the ephemeris data of the at least one RAN node; or
validity time of the ephemeris data of the at least one RAN node.

8. The BS of claim 6, wherein to acquire the verified UE location, the at least one processor is configured to cause the BS to:
transmit a report configuration for UE location verification; and
receive a report including parameters for the UE location verification from the UE, wherein
the parameters are associated with the at least one RAN node, and the verified UE location is acquired based on at least the ephemeris data and the parameters.

9. The BS of claim 8, wherein the report configuration further includes at least one of:
a Boolean indication indicating to the UE to transmit the report;
an enumeration indication indicating which one or more types of parameters to be reported;
a number indication indicating how many values for each type of parameter included in the report;
a first time duration with which the parameters included in the report are associated;
a second time duration in which the UE location verification is completed; or
an interval threshold between each two time points for to a type of parameters associated with the RAN node.

10. The BS of claim 8, wherein the parameters include, in different types, at least one of:
at least two timing advance (TA) values associated with at least two different time points respectively for the at least one RAN node;
at least two propagation delay values associated with at least two different time points respectively for the at least one RAN node; or
at least two propagation delay values associated with at least two RAN nodes respectively at a same time point, wherein the at least one RAN node includes the at least two RAN nodes.

11. The BS of claim 8, wherein to acquire the verified UE location, the at least one processor is configured to cause the BS to:
derive a UE location based on at least the parameters and ephemeris data; and
determine the verified UE location based on at least the derived UE location.

12. The BS of claim 8, wherein to acquire the verified UE location, the at least one processor is further configured to cause the BS to:
transmit assistance information to a location service (LCS) entity for UE location verification; and
receive the verified UE location from the LCS entity, wherein
the assistance information includes at least the parameters and the ephemeris data of at least one RAN node associated with the report.

13. The BS of claim 6, wherein the verified UE location includes at least one of:
a flag indication indicating whether the UE is located in a not-allowed or allowed country or region;
an indication indicting a country or region where the UE is located; or
a location in coordinates.

14. The BS of claim 6, wherein in a case that the verified UE location indicates that the UE is located in a not-allowed country or region, the determination includes at least:
denying access request from the UE or releasing a current RRC connection with the UE.

15. (canceled)

16. A processor for wireless communication, comprising:
at least one controller coupled with at least one memory and configured to cause the processor to:
receive a report configuration for user equipment (UE) location verification from a base station (BS), wherein the processor is included in the UE; and
transmit a report including parameters for the UE location verification to the BS, wherein the parameters include, in different types, at least one of:
at least two timing advance (TA) values associated with at least two different time points respectively for a radio access network (RAN) node;
at least two propagation delay values associated with at least two different time points respectively for the RAN node; or
at least two propagation delay values associated with at least two RAN nodes respectively at a time point.

17. The processor of claim 16, wherein the report configuration includes at least one of:
a Boolean indication indicating to the UE to transmit the report;
an enumeration indication indicating which one or more types of parameters to be reported;
a number indication indicating how many values for each type of parameter included in the report;
a first time duration with which the parameters included in the report are associated;
a second time duration within which the UE location verification is completed; or
an interval threshold between each two time points for a type of parameters associated with the RAN node.

18. The processor of claim 16, wherein each type of parameter within the report includes:
a full value as reference and at least one differential value; or
at least two full values.

19. The processor of claim 16, wherein the at least one controller is configured to cause the processor to transmit the report via at least one medium access control control element (MAC CE) in Msg3 payload or MsgA payload during random access (RA).

20. The processor of claim 16, wherein the at least one controller is further configured to cause the processor to:
enter or fallback to a radio resource control (RRC) idle state in response to receiving an indication indicting a failure of the UE location verification from the BS or expiry of a timer.

21. A method performed by a user equipment (UE), the method comprising:
receiving a report configuration for UE location verification from a base station (BS); and
transmitting a report including parameters for the UE location verification to the BS, wherein the parameters include, in different types, at least one of:
at least two timing advance (TA) values associated with at least two different time points respectively for a radio access network (RAN) node;
at least two propagation delay values associated with at least two different time points respectively for the RAN node; or
at least two propagation delay values associated with at least two RAN nodes respectively at a time point.
